(19) United States
(12) Patent Application Publication
(10) Pub. No.: US 2026/0152235 A1
(43) Pub. Date: Jun. 4, 2026

(54) VEHICLE FRAME STRUCTURE

(71) Applicant: TOYOTA JIDOSHA KABUSHIKI KAISHA, Toyota-shi (JP)

(72) Inventors: Katsuhiro SAKURAI, Toyota-shi (JP); Koji Matsueda, Toyota-shi (JP)

(73) Assignee: TOYOTA JIDOSHA KABUSHIKI KAISHA, Toyota-shi (JP)

(21) Appl. No.: 19/388,787

(22) Filed: Nov. 13, 2025

(30) Foreign Application Priority Data
Nov. 29, 2024 (JP) 2024-208926

(51) Int. Cl. B62D 25/08

(52) U.S. Cl. CPC B62D 25/082

(57) ABSTRACT

A cast body includes a vertical wall, a plurality of ribs, and a through hole. The vertical wall is provided on the side facing the motor unit, and extends in a vehicle front-rear direction and a vehicle up-down direction, The ribs extend outward in the vehicle width direction from the vertical wall. The through hole is provided within a region of the vertical wall surrounded by the ribs. Providing the ribs around the through hole can improve rigidity even though the through hole is formed in the vertical wall. This makes it possible to fasten a bolt to a mount portion of the motor unit.

### CROSS-REFERENCE TO RELATED APPLICATION

This application claims priority to Japanese Patent Application No. 2024-208926 filed on Nov. 29, 2024. The disclosure of the above-identified application, including the specification, drawings, and claims, is incorporated by reference herein in its entirety.

### BACKGROUND

### 1. Technical Field

The present disclosure relates to vehicle frame structures.

### 2. Description of Related Art

Japanese Unexamined Patent Application Publication No. 2013-177902 (JP 2013-177902 A) discloses a technique for bolting an engine to an engine mount bracket integrally formed with an aluminum die-cast chain case. In this related art, it is considered possible to reduce manufacturing costs and weight by integrally forming the chain case and the engine mount bracket.

### SUMMARY

Generally, when a vehicle frame member is manufactured by die casting, ribs etc. extending along the draft direction of the die are formed on the vehicle frame member in order to ensure the rigidity of the vehicle frame member. Moreover, a draft angle for facilitating removal from the die is provided on the vehicle frame member.

When a bolt fastening surface is provided along the draft angle on the vehicle frame member, it is desired to reduce the height of the ribs in order to reduce the possibility of interference with the ribs during insertion of a fastening tool for fastening a bolt. This may lead to a reduction in rigidity of the vehicle frame member.

In view of the above circumstances, an object of the present disclosure is to provide a vehicle frame structure including a vehicle frame member that is formed by die casting, ensures desired rigidity, and allows bolt fastening.

A vehicle frame structure of a first aspect includes a vehicle frame member provided by die casting. The vehicle frame member is provided outward of a motor unit in a vehicle width direction, and extends in a vehicle front-rear direction. The motor unit is disposed in a front or rear portion of a vehicle, and is configured to drive a wheel. The vehicle frame member includes: a vertical wall provided on a side facing the motor unit, and extending in the vehicle front-rear direction and a vehicle up-down direction; a plurality of ribs extending outward in the vehicle width direction from the vertical wall; and a through hole provided within a region of the vertical wall surrounded by the ribs. The through hole is configured to receive a fastening member that fastens the motor unit.

The vehicle frame structure of the first aspect includes the vehicle frame member provided outward of the motor unit in the vehicle width direction, and the motor unit is disposed in the front or rear portion of the vehicle and is configured to drive the wheel. The vehicle frame member extends in the vehicle front-rear direction, and is provided by die casting.

The vehicle frame member includes the vertical wall, the ribs, and the through hole. The vertical wall is provided on the side of the vehicle frame member facing the motor unit, and extends in the vehicle front-rear direction and the vehicle up-down direction. The ribs extend outward in the vehicle width direction from the vertical wall. In addition, the through hole is provided within a region of the vertical wall surrounded by the ribs.

The ribs are thus formed in a portion around the through hole formed in the vertical wall. This can improve rigidity even though the through hole is formed in the vertical wall.

Furthermore, in this aspect, the fastening member is inserted through the through hole formed in the vertical wall, and the motor unit is fastened to the vehicle frame member via the fastening member and the vertical wall. For example, compared to a case where a boss having an insertion hole is provided to extend from the vertical wall and the motor unit is fastened to the vehicle frame member via the fastening member, the length of the fastening member can be reduced, and fastening strength can be improved accordingly.

According to a vehicle frame structure of a second aspect, in the vehicle frame structure of the first aspect, a portion around the through hole is a thickened portion that is thicker than a general portion other than the portion around the through hole.

In the vehicle frame structure of the second aspect, the portion around the through hole formed in the vertical wall is the thickened portion that is thicker than the general portion other than the portion around the through hole. This can ensure the rigidity of the portion around the through hole (fastening portion) even though the through hole is formed in the vertical wall.

According to a vehicle frame structure of a third aspect, in the vehicle frame structure of the first or second aspect, a region inside the ribs in the vertical wall, that is, a region where the through hole is provided, is the thickened portion.

In the vehicle frame structure of the third aspect, the region inside the ribs in the vertical wall, that is, the region where the through hole is provided, is the thickened portion. This can ensure the rigidity of the portion around the through hole (fastening portion) including the base portions of the ribs, even though the through hole is formed.

According to a vehicle frame structure of a fourth aspect, in the vehicle frame structure of any one of the first to third aspects, the ribs serve as a truss-shaped rib having a substantially triangular shape, and the through hole is provided within the truss-shaped rib.

In the vehicle frame structure of the fourth aspect, the ribs form the truss-shaped rib having a substantially triangular shape. This can improve rigidity compared to a case where the ribs are formed in a frame shape on the vertical wall. Furthermore, since the through hole is provided within the truss-shaped rib, the rigidity of the portion around the through hole (fastening portion) can be improved, and the fastening strength by the fastening member can be improved.

As described above, the vehicle frame structure according to the present disclosure is formed by die casting, and has an excellent effect that it ensures the desired rigidity and allows bolt fastening.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a vehicle to which a vehicle frame structure according to an embodiment of the present disclosure is applied, as viewed obliquely from the front left and above;

FIG. 2 is an exploded perspective view of the vehicle to which the vehicle frame structure according to the embodiment is applied, as viewed obliquely from the front left and above;

FIG. 3 is an enlarged perspective view of a main portion in FIG. 2;

FIG. 4 is a side view of the vehicle to which the vehicle frame structure according to the embodiment is applied;

FIG. 5 is a schematic sectional view taken along line A-A in FIG. 4; and

FIG. 6 is a partial enlarged sectional view taken along line B-B in FIG. 2.

### DETAILED DESCRIPTION OF EMBODIMENTS

Hereinafter, a vehicle frame structure according to an embodiment of the present disclosure will be described with reference to the drawings. In the drawings, an arrow FR indicates the front side in the vehicle front-rear direction, and an arrow UP indicates the upper side in the vehicle up-down direction. An arrow RH indicates the right side in the vehicle width direction, and an arrow LH indicates the left side in the vehicle width direction. Hereinafter, the terms “front,” “rear,” “upper,” “lower,” “left,” and “right” refer to front and rear in the vehicle front-rear direction, upper and lower in the vehicle up-down direction, and left and right in the vehicle left-right direction (vehicle width direction), respectively, unless otherwise specified.

### Configuration of Vehicle Frame Structure

First, the configuration of the vehicle frame structure according to the embodiment will be described.

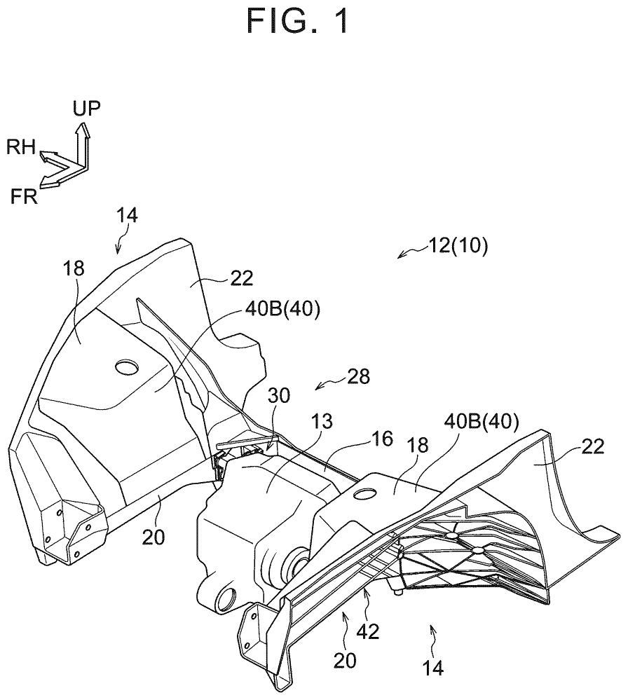

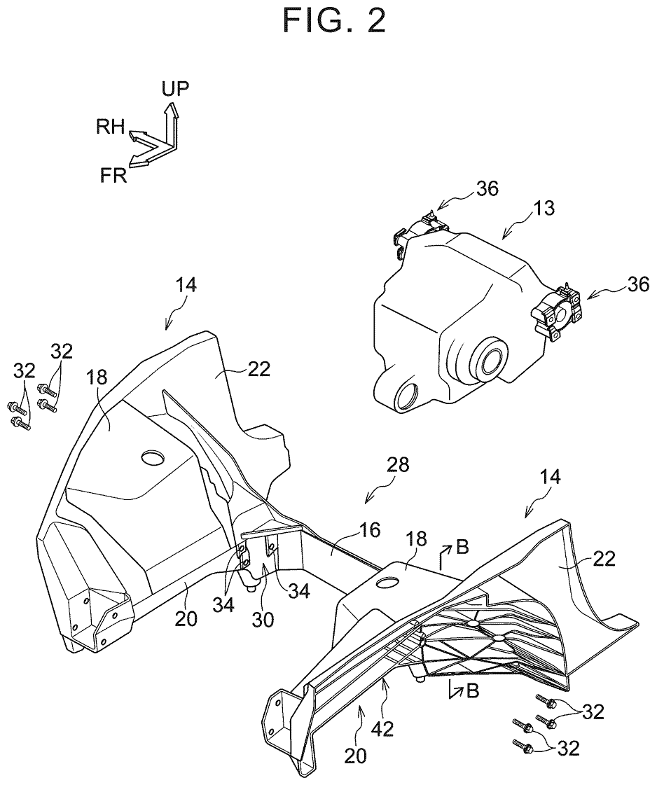

FIGS. 1 and 2 show a front portion (vehicle front portion) 12 of a vehicle 10 to which the vehicle frame structure of the present embodiment is applied. The vehicle 10 is, for example, a battery electric vehicle or fuel cell electric vehicle that runs on power generated by a motor unit 13. As shown in FIGS. 1 and 2, wheel houses 14 in which front wheels (not shown) are disposed extend in the vehicle front-rear direction on the right and left sides of the vehicle front portion 12. The right and left wheel houses 14 are connected by a cross member 16 extending in the vehicle width direction.

IA suspension tower 18 is provided on the inner side of each wheel house 14 in the vehicle width direction. Each suspension tower 18 supports the upper end of a corresponding one of front-wheel suspensions. A front side member 20 extending in the vehicle up-down direction and the vehicle front-rear direction is provided below each suspension tower 18. A front pillar 22 extending in the vehicle up-down direction and the vehicle front-rear direction is provided on the rear side of each wheel house 14.

In the present embodiment, for example, the pair of right and left wheel houses 14 including the suspension towers 18 and the front side members 20, the cross member 16, and the front pillars 22 are integrally formed by die casting using a material such as an aluminum alloy or a magnesium alloy (cast body 28). In the present embodiment, the cast body 28 has a substantially U-shape that is open toward the front of the vehicle, as viewed in plan.

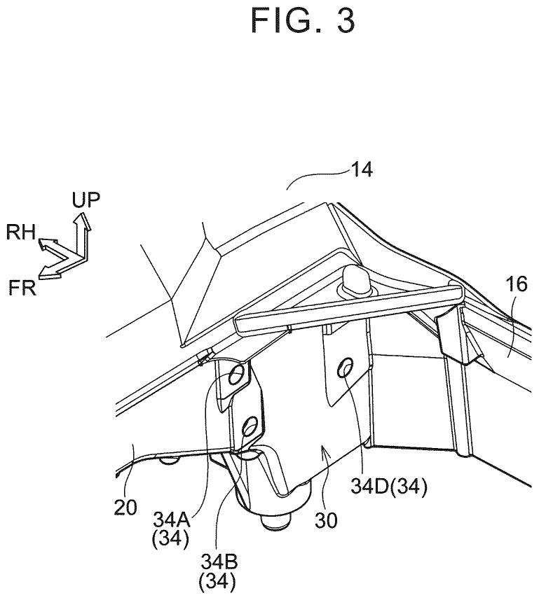

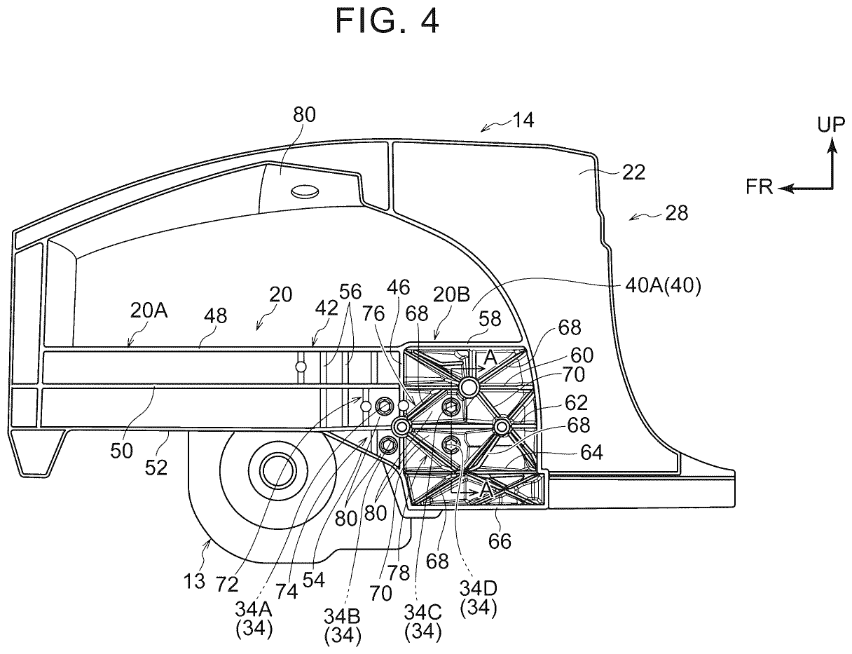

In the present embodiment, a mount portion (portion around a through hole) 30 is provided at each of the locations where the right and left wheel houses 14 and the cross member 16 are connected. An enlarged view of the mount portion 30 is shown in FIG. 3. As shown in FIG. 3, the mount portion 30 has through holes 34 through which bolts (fastening members) 32 can be inserted. FIG. 4 is a side view of the vehicle 10. Although there are four through holes 34 in this example, only three of them are shown in FIG. 3 due to the viewing angle of the vehicle front portion 12.

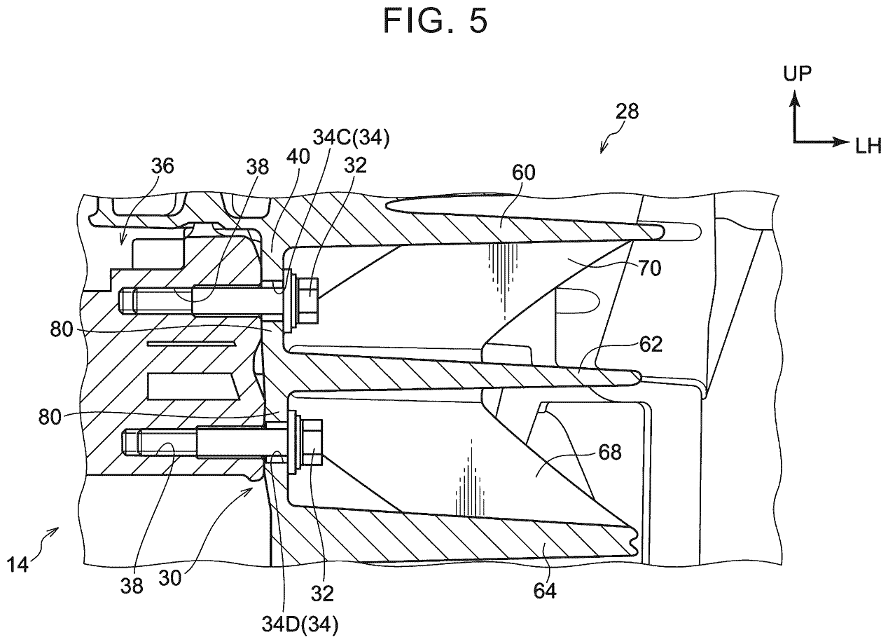

As shown in FIGS. 2 and 5, the motor unit 13 is provided with mount portions 36 each fastened to a corresponding one of the mount portions 30 of the cast body 28. Each mount portion 36 has fastening holes 38 into which the bolts 32 are screwed.

Therefore, in the present embodiment, the bolts 32 inserted through the through holes 34 in each mount portion 30 of the cast body 28 are screwed (fastened) into the fastening holes 38 in a corresponding one of the mount portions 36 of the motor unit 13. The motor unit 13 is thus installed (i.e., mounted) on the cast body 28. FIG. 5 is a sectional view taken along line A-A in FIG. 4.

Each of the right and left wheel houses 14 is provided with a suspension member (not shown). A front member extends in the vehicle width direction between the suspension members, and a mount portion is provided at the center of the front member in the extending direction of the front member. The motor unit 13 is thus supported at three points including this mount portion.

As shown in FIGS. 2 and 4, each wheel house 14 includes a vertical wall 40 that extends in the vehicle front-rear direction and the vehicle up-down direction. A plurality of ribs 42 extends along the vehicle width direction from a surface 40A on the outer side of the vertical wall 40 (the outer surface 40A of the vertical wall 40) in the vehicle width direction. FIG. 4 mainly shows the ribs 42 in a region around the mount portion 30.

The ribs 42 will now be described in detail. In the present embodiment, the front side member 20 of the cast body 28 is divided into a front portion 20A and a rear portion 20B along the vehicle front-rear direction. The front portion 20A and the rear portion 20B are separated by a partition wall (rib) 46 extending in the vehicle up-down direction and the vehicle width direction. The rear portion 20B protrudes downward beyond the front portion 20A.

An upper wall (rib) 48 is provided on the front portion 20A of the front side member 20. The upper wall 48 forms the upper end of the front portion 20A of the front side member 20, and extends in the vehicle front-rear direction and the vehicle width direction. A horizontal wall (rib) 50 is provided below the upper wall 48. The horizontal wall 50 extends in the vehicle front-rear direction and the vehicle width direction and substantially parallel to the upper wall 48. Furthermore, a lower wall (rib) 52 is provided below the horizontal wall 50. The lower wall 52 forms the lower end of the front portion 20A of the front side member 20, and extends in the vehicle front-rear direction and the vehicle width direction and substantially parallel to the horizontal wall 50.

An inclined wall 54 gradually sloping downward in the vehicle up-down direction toward the rear of the vehicle is provided at the rear end portion of the lower wall 52. The inclined wall 54 is connected to the partition wall 46. A plurality of vertical ribs 56 is provided along the vehicle up-down direction between the upper wall 48 and the horizontal wall 50, and between the horizontal wall 50 and the lower wall 52.

An upper wall (rib) 58 is provided on the rear portion 20B of the front side member 20. The upper wall 58 is connected to the upper wall 48 on the front portion 20A of the front side member 20, forms the upper end of the rear portion 20B of the front side member 20, and extends in the vehicle front-rear direction and the vehicle width direction. Horizontal walls (ribs) 60, 62 are provided below the upper wall 58. The horizontal walls 60, 62 are respectively connected to the horizontal wall 50 and the lower wall 52 on the front portion 20A of the front side member 20, and extend in the vehicle front-rear direction and the vehicle width direction.

Furthermore, a horizontal wall (rib) 64 is provided below the horizontal wall 62. The horizontal wall 64 extends in the vehicle front-rear direction and the vehicle width direction and substantially parallel to the horizontal wall 62. A lower wall (rib) 66 is provided below the horizontal wall 64. The lower wall 66 forms the lower end of the rear portion 20B of the front side member 20, and extends in the vehicle front-rear direction and the vehicle width direction and substantially parallel to the horizontal wall 64.

A plurality of upward-sloping ribs (ribs) 68 and a plurality of downward-sloping ribs (ribs) 70 are provided between the upper wall 58 and the horizontal wall 60, between the horizontal walls 60, 62, between the horizontal walls 62, 64, and between the horizontal wall 64 and the lower wall 66. The upward-sloping ribs 68 gradually slope upward in the vehicle up-down direction toward the rear of the vehicle. The downward-sloping ribs 70 gradually slope downward in the vehicle up-down direction toward the rear of the vehicle. The upward-sloping ribs 68 and the downward-sloping ribs 70 are provided continuously, forming an apparent truss structure together with the upper wall 58, the horizontal walls 60, 62, 64, and the lower wall 66.

As described above, each mount portion 30 of the cast body 28 has four through holes 34. Of the four through holes 34, through holes 34A, 34B located on the front portion 20A side of the mount portion 30 are disposed in the front portion 20A of the front side member 20. Through holes 34C, 34D located on the rear portion 20B side of the mount portion 30 are disposed in the rear portion 20B of the front side member 20.

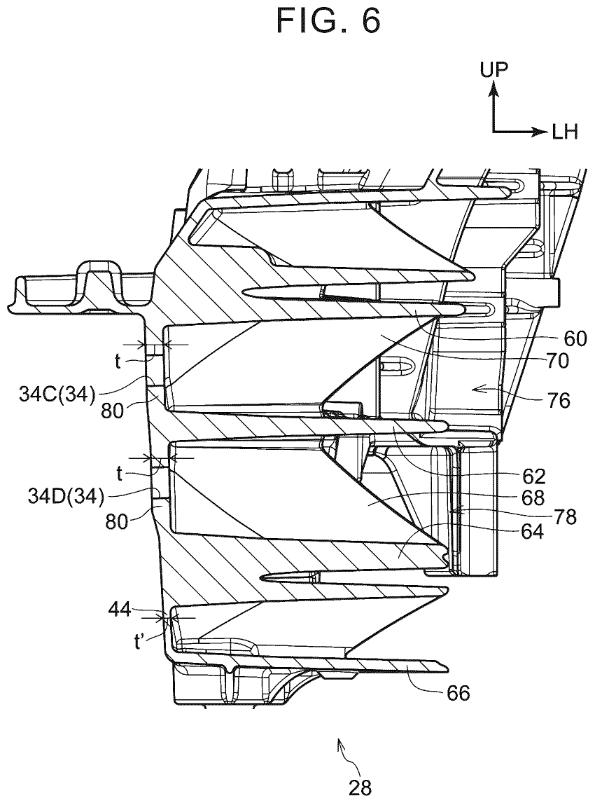

FIG. 6 is a partial enlarged sectional view taken along line B-B in FIG. 2. In the present embodiment, as shown in FIG. 6, the portion around the through hole 34 (mount portion 30) is formed as a thickened portion 80 having a thickness t greater than the thickness t′ of the general portion 44 other than the portion around the through hole 34. In the present embodiment, the ribs 42 are provided on the portion around the through hole 34. In the present embodiment, the shape of the ribs 42 provided on the portion around the through hole 34 is different between the through holes 34A, 34B and the through holes 34C, 34D.

For example, the through hole 34A is provided within a rectangular rib 72 formed by the horizontal wall 50, the lower wall 52, the vertical rib 56, and the partition wall 46. The through hole 34B is provided within a rectangular rib 74 formed by the lower wall 52, the inclined wall 54, the vertical rib 56, and the partition wall 46.

On the other hand, the through hole 34C is provided within a truss-shaped rib 76 formed by the horizontal walls 60, 62, the upward-sloping rib 68, and the downward-sloping rib 70. The through hole 34D is provided within a truss-shaped rib 78 formed by the horizontal walls 62, 64, the downward-sloping rib 70, and the upward-sloping rib 68.

Furthermore, in the present embodiment, the region inside the ribs 42 formed on the portion around the through hole 34 is the thickened portion 80. That is, each of the region inside the rectangular rib 72 where the through hole 34A is formed, the region inside the rectangular rib 74 where the through hole 34B is formed, the region inside the truss-shaped rib 76 where the through hole 34C is formed, and the region inside the truss-shaped rib 78 where the through hole 34D is formed is the thickened portion 80.

In the present embodiment, as shown in FIG. 5, the bolts 32 are inserted through the through holes 34 formed in the mount portion 30 of the cast body 28, and are screwed into the fastening holes 38 formed in the mount portion 36 of the motor unit 13. The bolts 32 are fastened into the fastening holes 38 using a fastening tool such as an impact wrench.

### Functions and Effects of Vehicle Frame Structure

Next, functions and effects of the vehicle frame structure according to the present embodiment will be described.

In the present embodiment, as shown in FIGS. 1 to 3, the vehicle front portion 12 to which the vehicle frame structure is applied is formed by die casting. The cast body 28 includes the vertical walls 40, the ribs 42, and the through holes 34.

Each vertical wall 40 is formed on the side facing the motor unit 13 in the vehicle front portion 12, and extends in the vehicle front-rear direction and the vehicle up-down direction. The ribs 42 extend outward in the vehicle width direction from the vertical wall 40. Furthermore, the through holes 34 are provided in the vertical wall 40, and are each formed within a corresponding one of the regions surrounded by the ribs 42.

As described above, in the present embodiment, the ribs 42 are provided around each through hole 34. This can improve the rigidity even though the through holes 34 are formed in the vertical wall 40.

In addition, in the present embodiment, the bolts 32 are inserted through the through holes 34 formed in the vertical wall 40, and the mount portion 36 of the motor unit 13 is fastened via the bolts 32 and the vertical wall 40 to the mount portion 30 of the cast body 28 that constitutes the vehicle front portion 12.

Each of the bolts 32 is inserted through a corresponding one of the through holes 34, and the mount portion 36 of the motor unit 13 is fastened via the bolts 32 and the vertical wall 40 to the mount portion 30 of the cast body 28 that constitutes the vehicle front portion 12.

Although not shown in the drawings, for example, compared to a case where bosses each having an insertion hole are provided to extend from the vertical wall 40 and the motor unit 13 is fastened to the cast body 28 via the bolts 32, the length of the bolts 32 can be reduced, and fastening strength can be improved accordingly. That is, in the present embodiment, the cast body 28 formed by die casting ensures the desired rigidity and allows bolt fastening.

Accordingly, in the present embodiment, even if, due to the draft angle provided for release from the die, the ribs are formed with a reduced height in the mount portion 30 of the cast body 28 to reduce the possibility of interference between a fastening tool for fastening the bolts 32 and the ribs, the rigidity desired to mount the motor unit 13 can still be ensured. In the present embodiment, it is therefore possible to fasten bolts directly to the mount portion 36 of the motor unit 13 without providing spacers etc. for ensuring rigidity.

By fastening the motor unit 13 directly to the cast body 28 via the bolts 32 in this manner, the mounting structure of the motor unit 13 can be simplified compared to a case where the motor unit is fixed via a bracket etc.

In the present embodiment, the portion around the through hole 34 (mount portion 30) is the thickened portion 80 having the thickness t greater than the thickness t′ of the general portion 44 other than the portion around the through hole 34. Accordingly, in the present embodiment, it is possible to ensure the rigidity of the mount portion 30 even through the through holes 34 are formed in the vertical wall 40.

Furthermore, in the present embodiment, the region inside the ribs 42 in the vertical wall 40, namely the region where the through hole 34 is formed, is the thickened portion 80. Accordingly, in the present embodiment, it is possible to ensure the rigidity of the mount portion 30 including the base portions of the ribs 42, even though the through holes 34 are formed.

To briefly describe the through holes 34 and the ribs 42, the through holes 34A, 34B in the mount portion 30 are respectively provided within the rectangular ribs 72, 74, and the through holes 34C, 34D in the mount portion 30 are respectively provided within the truss-shaped ribs 76, 78.

As described above, in the present embodiment, the truss-shaped ribs 76, 78 each having a substantially triangular shape are formed by the ribs 42. This can improve rigidity compared to a case where the ribs 42 are formed in a frame shape on the vertical wall 40. Furthermore, since the through holes 34C, 34D are respectively provided within the truss-shaped ribs 76, 78, the rigidity of the mount portion 30 can be improved, and the fastening strength by the bolts 32 can be improved.

Although the rectangular ribs 72, 74 are respectively provided in the portions around the through holes 34A, 34B, the truss-shaped ribs 76, 78 may be respectively provided in the portions around the through holes 34A, 34B instead of the rectangular ribs 72, 74.

The above embodiment illustrates an example in which the vehicle frame structure is applied to the vehicle front portion 12. However, it should be understood that the vehicle frame structure may be applied to a vehicle rear portion.

It should also be understood that the present disclosure is not limited to the above embodiment and may be carried out in various forms without departing from the spirit and scope of the present disclosure.

What is claimed is:

1. A vehicle frame structure comprising a vehicle frame member provided by die casting, the vehicle frame member being provided outward of a motor unit in a vehicle width direction and extending in a vehicle front-rear direction, the motor unit being disposed in a front or rear portion of a vehicle and configured to drive a wheel,
wherein the vehicle frame member includes
a vertical wall provided on a side facing the motor unit, and extending in the vehicle front-rear direction and a vehicle up-down direction,
a plurality of ribs extending outward in the vehicle width direction from the vertical wall, and
a through hole provided within a region of the vertical wall surrounded by the ribs, the through hole being configured to receive a fastening member that fastens the motor unit.

2. The vehicle frame structure according to claim 1, wherein a portion around the through hole is a thickened portion that is thicker than a general portion other than the portion around the through hole.

3. The vehicle frame structure according to claim 2, wherein a region inside the ribs in the vertical wall is the thickened portion, the region being a region where the through hole is provided.

4. The vehicle frame structure according to claim 1, wherein the ribs serve as a truss-shaped rib having a substantially triangular shape, and the through hole is provided within the truss-shaped rib.
